(19) United States
(12) Patent Application Publication
(10) Pub. No.: US 2025/0203480 A1
(43) Pub. Date: Jun. 19, 2025

(54) NON-3GPP INTEROPERABILITY NETWORK FUNCTION TO SUPPORT NETWORK OFFLOADING TO 3GPP NETWORKS

(71) Applicant: T-MOBILE INNOVATIONS LLC, Overland Park, KS (US)

(72) Inventors: Mason Tyler BOUFFARD, Seattle, WA (US); Sharath SOMASHEKAR, Overland Park, KS (US); Oscar CUMMINGS, Lynnwood, WA (US)

(21) Appl. No.: 18/538,752

(22) Filed: Dec. 13, 2023

(51) Int. Cl. H04W 36/22; H04W 28/02

(52) U.S. Cl. CPC H04W 36/22; H04W 28/0268

(57) ABSTRACT

Systems and methods provide an active mechanism that compares performance of Wi-Fi connectivity provided by a fixed wireless access point to cellular connectivity to determine the best option for a particular UE, based on a particular usage, at a particular point in time. Initially, an indication is received from a fixed wireless access point that is experiencing congestion that a UE has connected to the fixed wireless access point. If congestion metrics of the fixed wireless access point are determined to be above a threshold, collocated cells or neighboring cells that are not experiencing congestion are detected. Next, instructions are provided for the UE to: disconnect from the fixed wireless access point and connect to an alternate cell of the collocated cells or neighboring cells; or deprioritize Wi-Fi for a given amount of time.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for utilizing a non-3GPP interoperability network function to support network offloading to 3GPP networks. More particularly, in aspects set forth herein, systems and methods enable an active mechanism that compares performance of Wi-Fi connectivity provided by a fixed wireless access point to cellular connectivity to determine the best option for a particular UE, based on a particular usage, at a particular point in time. Initially, an indication is received from a fixed wireless access point that is experiencing congestion that a UE has connected to the fixed wireless access point. If congestion metrics of the fixed wireless access point are determined to be above a threshold, collocated cells or neighboring cells that are not experiencing congestion are detected. Next, instructions are provided for the UE to: disconnect from the fixed wireless access point and connect to an alternate cell of the collocated cells or neighboring cells; or deprioritize Wi-Fi for a given amount of time.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed;

FIG. 2 depicts an example of an offloading engine, in accordance with aspects herein;

FIG. 3 depicts a flow diagram of a method of utilizing a non-3GPP interoperability network function to support network offloading to 3GPP networks, in accordance with aspects herein; and

FIG. 4 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

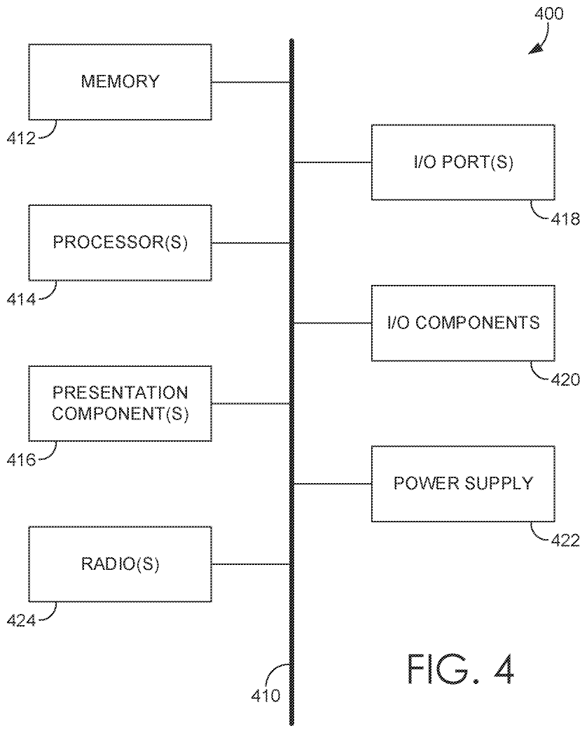

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 400 described herein with respect to FIG. 4.

Fixed wireless access uses the 4G and 5G radio spectrum to provide wireless broadband connectivity between a base station and a fixed wireless access point. For example, Wi-Fi at a location (e.g., home, business, etc.) may be established by utilizing a fixed wireless access point of a mobile network operator (MNO) or mobile virtual network operator (MVNO) rather than purchasing a fixed line Wi-Fi service. The fixed wireless access point essentially operates as the backhaul and router for devices in proximity, opening up its Wi-Fi portal to allow connectivity over specific bands made available in the radio network.

In one example, assume a fixed wireless access point has an ability to send 100 physical resource blocks (PRBs) in the uplink direction or downlink direction. If ten users are utilizing 90% of the resources (90 PRBs) only 10% of the resources (10 PRBs) remain for additional users. When additional users belonging to the same network as part of the fixed wireless access point are in range of the network, they are automatically connected to the Wi-Fi network because Wi-Fi is preferred over cellular when both are available.

Now assume an additional user is utilizing an application that requires 100 MBPs and enters the range of the network. As soon, as the user is in range, their device connects to the Wi-Fi network and they are limited to using only the remaining available 10 PRBs, which may translate into 10 MBPs. In this particular case, the user was better off remaining on the cellular network but their device automatically switched to the Wi-Fi network and performance is degraded.

In conventional systems, a device can only be removed from the Wi-Fi network if the device goes out of range of the Wi-Fi network or Wi-Fi is disabled. In other words, there is no active mechanism to compare performance of Wi-Fi connectivity provided by a fixed wireless access point to cellular connectivity to determine the best option for a particular UE, based on a particular usage, at a particular point in time.

The present disclosure is directed to systems, methods, and computer readable media for utilizing a non-3GPP interoperability network function to support network offloading to 3GPP networks. More particularly, in aspects set forth herein, systems and methods enable an active mechanism that compares performance of Wi-Fi connectivity provided by a fixed wireless access point to cellular connectivity to determine the best option for a particular UE, based on a particular usage, at a particular point in time. Initially, an indication is received from a fixed wireless access point that is experiencing congestion that a UE has connected to the fixed wireless access point. If congestion metrics of the fixed wireless access point are determined to be above a threshold, collocated cells or neighboring cells that are not experiencing congestion are detected. Next, instructions are provided for the UE to: disconnect from the fixed wireless access point and connect to an alternate cell of the collocated cells or neighboring cells; or deprioritize Wi-Fi for a given amount of time. In some aspects, congestion metrics of the alternate cell are verified to be less than the congestion metrics of the fixed wireless access point. When the congestion metrics of the alternate cell are more than the congestion metrics of the fixed wireless access point, instructions may be provided for the UE to reconnect to the fixed access wireless point.

In a first aspect of the present invention, computer-readable media is provided, the computer-readable media having computer-executable instructions embodied thereon that, when executed, perform a method of utilizing a non-3GPP interoperability network function to support network offloading to 3GPP networks. The method comprises receiving an indication, from a fixed wireless access point that is experiencing congestion, a user equipment (UE) has connected to the fixed wireless access point. The method also comprises determining congestion metrics of the fixed wireless access point are above a threshold. The method further comprises detecting collocated cells or neighboring cells that are not experiencing congestion. The method also comprises providing instructions for the UE to: disconnect from the fixed wireless access point and connect to an alternate cell of the collocated cells or neighboring cells; or deprioritize Wi-Fi for a given amount of time.

A second aspect of the present disclosure is directed to a method of utilizing a non-3GPP interoperability network function to support network offloading to 3GPP networks. The method comprises receiving an indication, from a fixed wireless access point that is experiencing congestion, a user equipment (UE) has connected to the fixed wireless access point. The method also comprises determining congestion metrics of the fixed wireless access point are above a threshold. The method further comprises detecting collocated cells or neighboring cells that are not experiencing congestion. The method also comprises verifying congestion metrics for an alternate cell of the collocated cells or neighboring cells are less than the congestion metrics of the fixed wireless access point. The method further comprises providing instructions for the UE to: disconnect from the fixed wireless access point and connect to the alternate cell of the collocated cells or neighboring cells; or deprioritize Wi-Fi for a given amount of time.

Another aspect of the present disclosure is directed to a system that utilizes a non-3GPP interoperability network function to support network offloading to 3GPP networks. The system comprises a UE and an offloading engine that: receives an indication, from a fixed wireless access point that is experiencing congestion, a user equipment (UE) has connected to the fixed wireless access point; determines congestion metrics of the fixed wireless access point are above a threshold; detects collocated cells or neighboring cells that are not experiencing congestion; and provides instructions for the UE to: disconnect from the fixed wireless access point and connect to an alternate cell of the collocated cells or neighboring cells; or deprioritize Wi-Fi for a given amount of time.

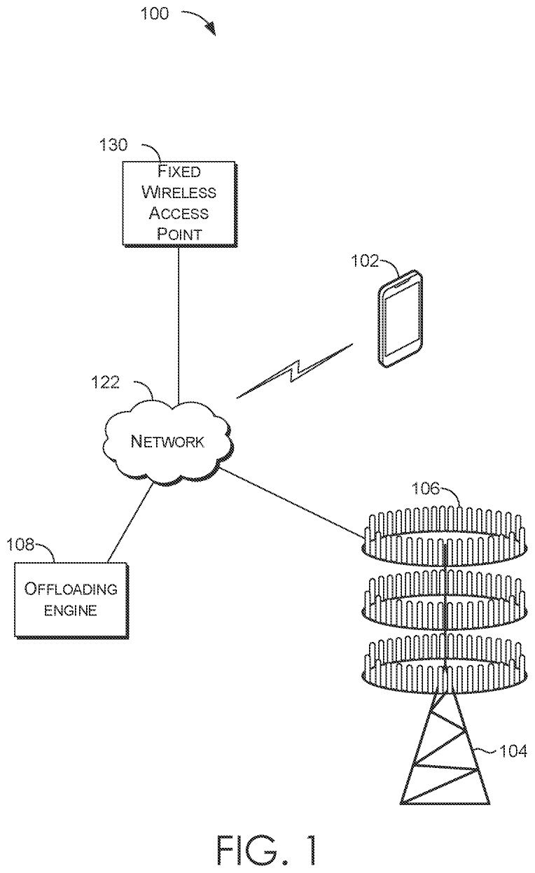

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network cell may comprise a base station to facilitate wireless communication between a communications device within the network cell, such as communications device 400 described with respect to FIG. 4, and a network. As shown in FIG. 1, a communications device may be a UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize network 122 to communicate with other computing devices (e.g., mobile device(s), a server(s), a personal computer(s), etc.). In embodiments, network 122 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 122 may include multiple networks, as well as being a network of networks, but is shown in more simple form so as to not obscure other aspects of the present disclosure. Network 122 may be part of a telecommunications network that connects subscribers to their immediate service provider. In embodiments, network 122 is associated with a telecommunications provider that provides services to user devices, such as UE 102. For example, network 122 may provide voice services to user devices or corresponding users that are registered or subscribed to utilize the services provided by a telecommunications provider. Although it is contemplated network 122 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), or the like, network 122 is depicted in FIG. 1 as a 5G network.

The network environment 100 may include a database (not shown). The database may be similar to the memory component 412 in FIG. 4 and can be any type of medium that is capable of storing information. The database can be any collection of records (e.g., congestion metrics, collocated or neighboring cells, etc.). In one embodiment, the database includes a set of embodied computer-executable instructions that, when executed, facilitate various aspects disclosed herein. These embodied instructions will variously be referred to as “instructions” or an “application” for short.

As previously mentioned, the UE 102 may communicate with other devices by using a base station, such as base station 104. In embodiments, base station 104 is a wireless communications station that is installed at a fixed location, such as at a radio tower, as illustrated in FIG. 1. The radio tower may be a tall structure designed to support one or more antennas 106 for telecommunications and/or broadcasting. In other embodiments, base station 104 is a mobile base station. The base station 104 may be an MMU and include gNodeB for mMIMO/5G communications via network 122. In this way, the base station 104 can facilitate wireless communication between UE 102 and network 122.

As stated, the base station 104 may include a radio (not shown) or a remote radio head (RRH) that generally communicates with one or more antennas associated with the base station 104. In this regard, the radio is used to transmit signals or data to an antenna 106 associated with the base station 104 and receive signals or data from the antenna 106. Communications between the radio and the antenna 106 can occur using any number of physical paths. A physical path, as used herein, refers to a path used for transmitting signals or data. As such, a physical path may be referred to as a radio frequency (RF) path, a coaxial cable path, cable path, or the like.

The antenna 106 is used for telecommunications. Generally, the antenna 106 may be an electrical device that converts electric power into radio waves and converts radio waves into electric power. The antenna 106 is typically positioned at or near the top of the radio tower as illustrated in FIG. 1. Such an installation location, however, is not intended to limit the scope of embodiments of the present invention. The radio associated with the base station 104 may include at least one transceiver configured to receive and transmit signals or data.

The UE 102 may also communicate with other devices by using an access point, such as fixed wireless access point 130. In embodiments, the fixed wireless access point 130 uses the 4G and 5G radio spectrum to provide wireless broadband connectivity between the fixed wireless access point 130 and the base station 104 and, as illustrated in FIG. 1. In this way, the fixed wireless access point 130 can facilitate wireless communication between UE 102 and network 122.

Continuing, the network environment 100 may further include an offloading engine 108. The offloading engine 108 may be configured to, among other things, support network offloading to 3GPP networks, in accordance with the present disclosure. Though offloading engine 108 is illustrated as a standalone device (e.g., a server having one or more processors) in FIG. 1, it may be a service provided via the base station 104, the network 122, part of an edge compute cluster, or may be remotely located.

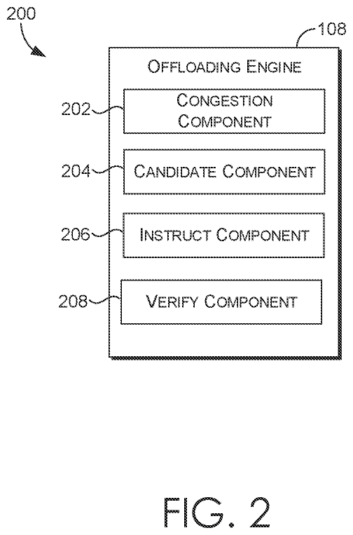

Referring now to FIG. 2, the offloading engine 108 may include, among other things, a congestion component 202, a candidate component 204, an instruct component 206, and a verify component 208. The offloading engine 108 may provide, among other things, an active mechanism that compares performance of Wi-Fi connectivity provided by a fixed wireless access point to cellular connectivity to determine the best option for a particular UE, based on a particular usage, at a particular point in time. The offloading engine 108 may also serve as an interconnect between an operator network packet data core via the gateway to the external internet and any Wi-Fi access point, such that ongoing data sessions can have packets forwarded to either a Wi-Fi access point or a gNodeB, so that any mobility between the two handover without delay in a data session.

Congestion component 202 generally receives an indication a 3GPP cellular enabled device (such as a UE) has entered the service area of a fixed wireless access point. For example, the fixed wireless access point may be in communication with congestion component 202 and reports that a UE has joined the fixed wireless access point. Moreover, congestion component 202 may determine congestion metrics of the fixed wireless access point are above a threshold. In some aspects, a gNodeB collects metrics and the congestion component 202 evaluates the metrics with a set of heuristics or a machine learning algorithm to determine the level of congestion on the cell and the fixed wireless access point.

Candidate component 204 generally detects collocated cells or neighboring cells that are not experiencing congestion. For example, candidate component 204 may maintain a lookup table that utilizes cell location or position to keep a reference of collocated and geographically nearby cells. Candidate component 204 may retrieve congestion metrics of the collocated cells or neighboring cells from a neighbor relation table stored and maintained by the gNodeB.

Instruct component 206 generally provides instructions for the UE. For example, the instructions may be to disconnect from Wi-Fi and seek a cellular channel with a given frequency. In another example, the instructions may be to deprioritize Wi-Fi for a given amount of time. In another example, the instructions may be to connect to a particular Wi-Fi access point when cellular experience becomes worse (via reference signal received power or congestion metrics).

Verify component 208 generally verifies congestion metrics of the alternate cell are less than the congestion metrics of the fixed wireless access point. When the congestion metrics of the alternate cell are more than the congestion metrics of the fixed wireless access point, verify component 208 provides instructions for the UE to reconnect to the fixed access wireless point.

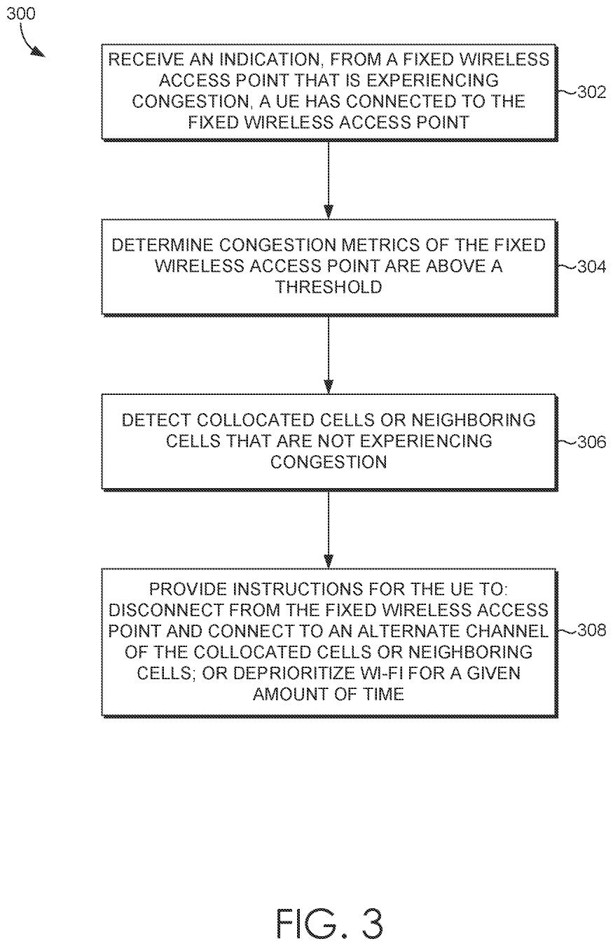

In FIG. 3, a flow diagram is provided depicting a method 300 of utilizing a non-3GPP interoperability network function to support network offloading to 3GPP networks, in accordance with aspects of the present invention. Method 300 may be performed by any computing device (such as computing device described with respect to FIG. 4) with access to an offloading engine (such as the one described with respect to FIG. 1 or 2) or by one or more components of the network environment described with respect to FIG. 1 (such as base station 104 or offloading engine 108).

Initially, at step 302, an indication is received from a fixed wireless access point that is experiencing congestion that indicates a UE has connected to the fixed wireless access point. For example, the fixed wireless access point may be in communication with a compute resource or application server (e.g., an offloading engine) and reports that a UE has joined the fixed wireless access point.

At step 304, congestion metrics of the fixed wireless access point are determined to be above a threshold. In some aspects, a gNodeB collects metrics and the offloading engine evaluates the metrics with a set of heuristics or a machine learning algorithm to determine the level of congestion on the cell and the fixed wireless access point. In some aspects, the congestion metrics are determined at a cell level based on physical resource blocks utilization and buffer length of currently connected user devices. Additionally or alternatively, the congestion metrics may be determined at a quality of service class level based on physical resource blocks utilization and buffer length of currently connected user devices. Additionally or alternatively, the congestion metrics may be determined at a network slice level based on physical resource blocks utilization and buffer length of currently connected user devices. In various aspects, buffer length may be determined by age of payload or size of payload.

At step 306, collocated cells or neighboring cells that are not experiencing congestion are detected. In some aspects, congestion metrics of the alternate cell are verified to be less than the congestion metrics of the fixed wireless access point. In one example, the collocated cells or neighboring cells are detected based on a congestion metrics tracking component (e.g., a lookup table maintained by the offloading engine). The lookup table may utilize cell location or position to keep a reference of collocated and geographically nearby cells. In another example, congestion metrics of the collocated cells or neighboring cells are retrieved from a neighbor relation table stored and maintained by the gNodeB. The congestion metrics tracking component tracks buffer lengths and ages for the collocated cells or neighboring cells. In some aspects, the buffer lengths are determined by age of payload or size of payload. In another example, location of the user device, a base station, or an offloading engine may be utilized to identify the collocated cells or neighboring cells.

At step 308, instructions are provided for the UE to: disconnect from the fixed wireless access point and connect to an alternate cell of the collocated cells or neighboring cells; or deprioritize Wi-Fi for a given amount of time. When the congestion metrics of the alternate cell are more than the congestion metrics of the fixed wireless access point, in some aspects, instructions are provided for the UE to reconnect to the fixed access wireless point.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions-including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-readable media having computer-executable instructions embodied thereon that, when executed, perform a method of utilizing a non-3GPP interoperability network function to support network offloading to 3GPP networks, the method comprising:
receiving an indication, from a fixed wireless access point that is experiencing congestion, a user equipment (UE) has connected to the fixed wireless access point;
determining congestion metrics of the fixed wireless access point are above a threshold;
detecting collocated cells or neighboring cells that are not experiencing congestion; and
providing instructions for the UE to: disconnect from the fixed wireless access point and connect to an alternate cell of the collocated cells or neighboring cells; or deprioritize Wi-Fi for a given amount of time.

2. The media of claim 1, further comprising verifying congestion metrics of the alternate cell are less than the congestion metrics of the fixed wireless access point.

3. The media of claim 1, wherein the congestion metrics are determined at a cell level based on physical resource blocks utilization and buffer length of currently connected user devices.

4. The media of claim 1, wherein the congestion metrics are determined at a quality of service class level based on physical resource blocks utilization and buffer length of currently connected user devices.

5. The media of claim 1, wherein the congestion metrics are determined at a network slice level based on physical resource blocks utilization and buffer length of currently connected user devices.

6. The media of claim 1, wherein detecting the collocated cells or neighboring cells is based on a congestion metrics tracking component.

7. The media of claim 6, wherein the congestion metrics tracking component tracks buffer lengths and ages for the collocated cells or neighboring cells.

8. The media of claim 7, wherein the buffer lengths are determined by age of payload or size of payload.

9. The media of claim 1, further comprising utilizing location of the user device to identify the collocated cells or neighboring cells.

10. The media of claim 1, further comprising retrieving congestion metrics of the collocated cells or neighboring cells from a gNodeB.

11. The media of claim 1, providing instructions for the UE to reconnect to the fixed access wireless point when the congestion metrics of the alternate cell are more than the congestion metrics of the fixed wireless access point.

12. A method of utilizing a non-3GPP interoperability network function to support network offloading to 3GPP networks, the method comprising:
receiving an indication, from a fixed wireless access point that is experiencing congestion, a user equipment (UE) has connected to the fixed wireless access point;
determining congestion metrics of the fixed wireless access point are above a threshold;
detecting collocated cells or neighboring cells that are not experiencing congestion;
verifying congestion metrics for an alternate cell of the collocated cells or neighboring cells are less than the congestion metrics of the fixed wireless access point; and
providing instructions for the UE to: disconnect from the fixed wireless access point and connect to the alternate cell of the collocated cells or neighboring cells; or deprioritize Wi-Fi for a given amount of time.

13. The method of claim 12, wherein the congestion metrics are based on physical resource blocks utilization and buffer length of currently connected user devices.

14. The method of claim 13, wherein the congestion metrics are determined at a cell level, a quality of service class level, or a network slice level.

15. The method of claim 12, further comprising utilizing location of the user device to identify the collocated cells or neighboring cells.

16. The method of claim 12, further comprising retrieving congestion metrics of the collocated cells or neighboring cells from a gNodeB.

17. The method of claim 12, providing instructions for the UE to reconnect to the fixed access wireless point when the congestion metrics of the alternate cell are more than the congestion metrics of the fixed wireless access point.

18. A system that utilizes a non-3GPP interoperability network function to support network offloading to 3GPP networks, the system comprising:
a user equipment (UE); and
an offloading engine that:
receives an indication, from a fixed wireless access point that is experiencing congestion, a user equipment (UE) has connected to the fixed wireless access point;
determines congestion metrics of the fixed wireless access point are above a threshold;
detects collocated cells or neighboring cells that are not experiencing congestion; and
provides instructions for the UE to: disconnect from the fixed wireless access point and connect to an alternate cell of the collocated cells or neighboring cells; or deprioritize Wi-Fi for a given amount of time.

19. The system of claim 18, further comprising verifying congestion metrics for the alternate cell of the collocated cells or neighboring cells are less than the congestion metrics of the fixed wireless access point.

20. The system of claim 18, further comprising providing instructions for the UE to reconnect to the fixed access wireless point when the congestion metrics of the alternate cell are more than the congestion metrics of the fixed wireless access point.
